(19) United States
(12) Patent Application Publication
(10) Pub. No.: US 2014/0181863 A1
(43) Pub. Date: Jun. 26, 2014

(54) INTERNET PROTOCOL TELEVISION SERVICE

(71) Applicant: KT Corporation, Seongnam-si (KR)

(72) Inventors: Jongho SHIN, Seoul (KR); Seonghyeon YANG, Seoul (KR); Du-seong CHANG, Anyang-si (KR)

(73) Assignee: KT Corporation, Seongnam-si (KR)

(21) Appl. No.: 14/140,636

(22) Filed: Dec. 26, 2013

(30) Foreign Application Priority Data
Dec. 26, 2012 (KR) 10-2012-0153671

(51) Int. Cl. H04N 21/47; H04N 21/278

(52) U.S. Cl. CPC H04N 21/47; H04N 21/278
USPC 725/37

(57) ABSTRACT

In one example embodiment, a system includes an end device configured to: display an image, receive an input to select an object depicted on the displayed image, and transmit information regarding the object; and a server configured to: receive the information regarding the object from the end device, store the received information regarding the object with a time of receipt, identify at least one service associated with the object with reference to the received information regarding the object, and transmit service information regarding the identified at least one service to the end device.

### TECHNICAL FIELD

The embodiments described herein pertain generally to an internet protocol television service.

### BACKGROUND

An internet protocol television (IPTV) service provider may provide a service that integrates security of a telecommunication network, content provided by a broadcast television network and features of the Internet; and may further provide voice, data, and video services over one connection simultaneously. Therefore, a user may use a client device to not only make calls, access the Internet, and watch TV, but also enjoy more data, voice, and video integrated services through the IPTV service, serially or in parallel.

### SUMMARY

In one example embodiment, a system may include an end device configured to: display an image, receive an input to select an object depicted on the displayed image, and transmit information regarding the object; and a server configured to: receive the information regarding the object from the end device, store the received information regarding the object with a time of receipt, identify at least one service associated with the object with reference to the received information regarding the object, and transmit service information regarding the identified at least one service to the end device.

In another example embodiment, a server may include a receiver configured to receive, from an end device, an image of an object; an object recognizer configured to: recognize the object from the image, and retrieve object information regarding the object; an object database configured to store the object information; a service database configured to store service information regarding a plurality of services; a service manager configured to identify at least one of the plurality of services based on a correspondence between the retrieved object information and any of the stored service information; and a transmitter configured to transmit the service information corresponding to the identified at least one service to the end device.

In yet another example embodiment, a method performed under control of a server may include receiving, from an end device, information regarding an object depicted on an image displayed by the end device; identifying at least one service associated with the object from among a plurality of services with reference to the received information regarding the object; and transmitting service information regarding the identified at least one service to the end device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which one or more embodiments of an internet protocol television service may be implemented, in accordance with various embodiments described herein;

FIGS. 2A to 2D show aspects of an example end device by which at least portions of an internet protocol television service may be implemented, in accordance with various embodiments described herein;

FIGS. 3A to 3C show aspects of another example end device by which at least portions of an internet protocol television service may be implemented, in accordance with various embodiments described herein;

FIGS. 4A to 4C show aspects of still another example end device by which at least portions of an internet protocol television service may be implemented, in accordance with various embodiments described herein;

FIG. 5 shows an example server by which at least portions of an internet protocol television service may be implemented, in accordance with various embodiments described herein;

FIG. 6 shows an example object database of a server by which at least portions of an internet protocol television service may be implemented, in accordance with various embodiments described herein;

FIG. 7 shows an example service database of a server by which at least portions of an internet protocol television service may be implemented, in accordance with various embodiments described herein;

FIG. 8 shows an example processing flow of operations by which at least portions of an internet protocol television service may be implemented, in accordance with various embodiments described herein; and

FIG. 9 shows an illustrative computing embodiment, in which any of the processes and sub-processes of an internet protocol television service may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

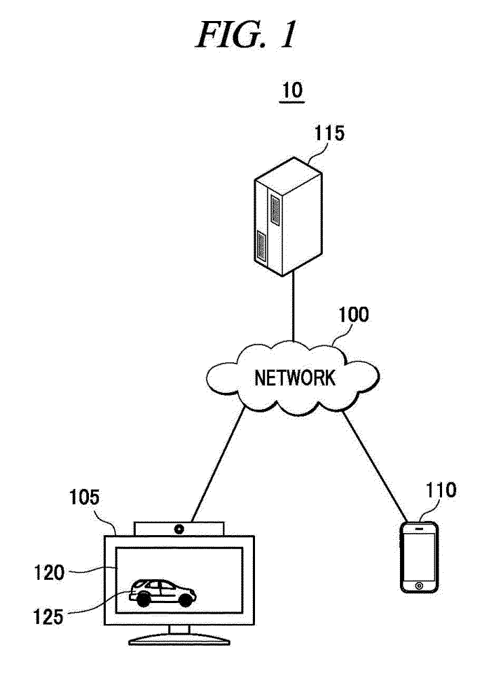

FIG. 1 shows an example system configuration 10 in which one or more embodiments of an internet protocol television service may be implemented, in accordance with various embodiments described herein. As depicted in FIG. 1, system configuration 10 may include, at least, an end device 105, a mobile device 110 and a server 115.

Network 100 may refer to a telecommunication network that may be configured to communicatively couple two or more of mobile device 105, end device 110 and server 115. As a non-limiting example, network 100 may include a wired network such as a LAN (Local Area Network), a WAN (Wide Area Network), a VAN (Value Added Network) or the like; or various other wireless networks such as a mobile radio communication network including at least one of a 3rd generation (3G) mobile telecommunications network, a 4th or 5th generation mobile telecommunications network; various other mobile telecommunications networks; a satellite network; WiBro (Wireless Broadband Internet); Mobile WiMAX; Wi-Fi network; HSDPA (High Speed Downlink Packet Access); or the like. Alternatively, network 100 may include at least one of a near field communication (NFC), Bluetooth, or peer to peer (P2P) communication protocol.

End device 105 may refer to any type of a smart television, a smart phone, a set-top box (STB) that may or may not have a display coupled thereto, a notebook computer, a personal computer, a tablet computer, a phablet device, or a personal communication terminal, that is capable of, at least, receiving and/or playing internet protocol television (IPTV) content.

End device 105 may be configured to display an image 120 on a display that may be part of, or communicatively coupled to, end device 105. More particularly, end device 105 may be configured to play or reproduce, on the display, IPTV content that may include at least one of video-on-demand (VOD) content, real-time broadcasting content or user interactive content (e.g., games). End device 105 may be configured to receive, via network 100, IPTV content from server 115 or an IPTV headend server that may be configured to provide IPTV content or services. Image 120 may refer to at least one of a picture, a frame, or a scene of the IPTV content that is played or reproduced by end device 105.

In accordance with some embodiments, end device 105 may be further configured to receive an input to select an object 125 depicted on image 120. For example, the input may be generated by a user of end device 105 or a user of mobile device 110. For example, object 125 may be one of multiple displayed multiple distinguishable objects included in IPTV content that may be displayed on image 120. Non-limiting examples of the input may include at least one of a voice command, a gesture command, a text command, a touch command or a pointer command.

End device 105 may be configured to extract an image of object 125 from image 120, upon end device 105 receiving the input to select object 125. For example, end device 105 may be configured to extract the image of object 125 from image 120 by using any well-known object recognition or image extracting schemes. Further, end device 105 may be configured to transmit, to server 115, information regarding and including selected object 125, which includes the extracted image of object 125. End device 105 may be configured to then receive, from server 115, service information regarding at least one service that may be facilitated with regard to that object 125.

In some embodiments, end device 105 may be configured to extract images of multiple objects from image 120, and to transmit information regarding and including one or more of the extracted images of the multiple objects to server 115, upon end device 105 receiving a predefined input such as one or more predefined gesture commands, one or more predefined touch commands, or one or more predefined voice commands. For example, but not as a limitation, end device 105 may be configured to extract images of one or more objects depicted on image 120, when end device 105 receives at least one of the predefined touch inputs, e.g., a user of end device 105 may draw a star on displayed image 120. Information regarding the input to extract at least one of the images of one or more displayed objects may be predefined or pre-registered in end device 105 by a user who controls operation of end device 105. For example, the information regarding the input may include condition upon which, if a predefined input is received by end device 105, one or more images of objects are to be extracted. Alternatively, information regarding the input to extract images of one or more displayed objects may be transmitted from server 105 to end device 105, and stored in a memory of end device 105.

In some other embodiments, end device 105 may be configured to extract an image of a predefined object from image 120, and to transmit information regarding and including the extracted image of the predefined object to server 115, upon end device 105 receiving a predefined input such as one or more predefined gesture commands, one or more predefined touch commands, or one or more predefined voice commands. The predefined object may refer to an object that is supposed to be selected upon end device 105 receiving one or more of the predefined inputs. For example, but not as a limitation, the predefined object may refer to an object that an advertiser or a manufacturer of the object wants to advertise or sell.

For example, an owner or entity that controls an operation of server 115 or an advertiser or a manufacturer of the predefined object may register, with server 115, information regarding the predefined object and the one or more corresponding predefined inputs to select the predefined object. Further, end device 105 may be configured to receive the information regarding the predefined object and the corresponding one or more predefined inputs from server 115. End device 105 may be further configured to store the received information in a corresponding memory, and to extract the image of the predefined object from image 120 based at least in part on the received information. For example, but not as a limitation, end device 105 may be configured to extract an image of a predefined object, e.g., a necklace, depicted on image 120, when end device 105 receives a predefined touch input, e.g., a user of end device 105 makes a touch input drawing a triangle shape on displayed image 120,.

End device 105 may be configured to receive, from server 115, service information regarding at least one service that may be associated with extracted object 125. Non-limiting examples of services that may be executed by server 115, with regard to an extracted object, may include searching for content, recommending content, displaying content, displaying an advertisement, recommending a service, and/or searching a map. As referenced herein, the “content” that may searched, recommended, and/or displayed may include, as non-limiting examples, a review of the extracted object, a photo of the extracted object, additional information regarding the extracted object (e.g., a name, a cost, a color, a size, etc.) or a publication article regarding the extracted object. Further, as non-limiting examples, the information regarding services that may be associated with extracted object 125 may include at least one of an advertisement about object 125, a review of object 125 by other users, or an online commerce service associated with object 125. Examples of an online commerce service associated with object 125 may include providing a uniform resource locator (URL) of an e-commerce website from which a purchase of object 125 may be made or a map of a shopping mall to direct a user to a store from which a purchase of object 125 may be made.

End device 105 may be further configured to display the received service information regarding the at least one service associated with object 125 on the display that may be part of, or communicatively coupled to, end device 105. Further, end device 105 may be configured to display, on the display, the service information that includes a list of services that may be rendered with regard to extracted object 125.

Further, in some embodiments, end device 105 may be configured to receive an input to select a service from the list of available services, and the service information regarding the selected service may be displayed on end device 105. Further, end device 105 may be configured to transmit the received input to select the service to server 115.

In some embodiments, mobile device 110 may be configured to transmit, to end device 105, at least one signal that represents an input to select object 125 on image 120 depicted by end device 105. Non-limiting examples of the input may include at least one voice command, at least one gesture command, at least one text command, at least one touch command, or at least one pointer command. Further, mobile device 110 may be configured to transmit, to end device 105, at least one signal that represents an input to select a service from the list of services displayed by end device 105.

Mobile device 110 may refer to a smart phone, a remote controller, a tablet computer, a phablet device, or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminal that may function as a remote controller that has a remote control user interface including directional keys, a function selection key, alphanumeric keys, channel controller keys, and volume controller keys, etc.

Server 115 may refer to one or more servers or apparatuses hosted and/or supported by a service providing organization or entity that provides IPTV services or content including real-time broadcasting services, video-on-demand (VOD) services, and/or user interactive services (e.g., games) to end device 105. Non-limiting examples of server 115 may include an Internet service provider, i.e., ISP; application service provider, i.e., ASP; storage service provider, i.e., SSP; and television service provider, i.e., cable TV, DSL and DBS.

Server 115 may be configured to receive, from end device 105, information regarding selected object 125. The received information regarding selected object 125 may include an image of object 125. In some embodiments, server 115 may be configured to store the received information regarding object 125 in a corresponding database in association with an identifier of end device 105 and/or with a time stamp of receipt. Non-limiting examples of the identifier of end device 105 may include an internet protocol (IP) address of end device 105, a serial number assigned to end device 105, or a unique identifier of end device 105. Further, server 115 may be configured to store the received information regarding object 125 in a time sequence of receiving the information from end device 105. For example, server 115 may have a queue database that stores the received information regarding selected objects in the order of receipt.

Server 115 may be configured to identify at least one service that may be associated with selected object 125, based on the received information regarding object 125. In some embodiments, server 115 may be configured to identify and determine the at least one service from among multiple services that are executable by server 115, based at least in part on information regarding environmental conditions. Non-limiting examples of the information regarding environment conditions may include at least one of a current time, current weather conditions, a current location of end device 105, or a service that was previously selected by end device 105. For example, but not as a limitation, the services that may be executable by server 115 may include searching for content, recommending content, displaying content, displaying an advertisement, recommending a service, and/or searching a map.

For example, if server 115 receives, from end device 105, information including and/or regarding selected object 125, e.g., a scone, which may include an image of object 125 while it is raining on a cold day, an application hosted on server 115 may be configured to associate a service with an environmental condition at which the information including and/or regarding selected object 125 is received, i.e., a rainy and cold weather condition. For example, server 115 may be configured to determine that the user of end device 105 wants to eat hot foods with a scone. So, server 115 may be configured to identify a service that recommends a recipe for hot soup or hot coffee which goes well with scones on a cold day. For another example, if server 115 receives information regarding another selected object 125, e.g., shoes, from end device 105 which is located at a shopping center or a shopping mall, server 115 may be configured to identify a service that searches for a map or a location of a shoe store that sells selected object 125, e.g., shoes, in the shopping center or shopping mall.

Server 115 may be configured to transmit service information regarding at least one of the identified services to end device 105. As a non-limiting example, the information regarding the services may include at least one of an advertisement about object 125, a review of object 125 by other users, or an online commerce service associated with object 125. In some embodiments, server 115 may be configured to execute one of the identified services by calling a service agent to execute one of the identified services. Further, server 115 may be configured to receive a result of the executed service from the service agent, and to generate the service information regarding the identified service based at least in part on the received result. By way of example, but not limitation, the service agent may refer to a module, a processor or an engine that executes a service. Further, the service agent may be located in at least one of server 115, or an IPTV headend server that may be communicatively coupled to end device 105 and/or server 115. The service agent may include at least one of a search agent, a recommendation agent, a content providing agent, or an advertisement agent.

Further to the aforementioned example, server 115 may be configured to access a recommendation agent that may be configured to recommend recipes for foods, and to receive a recipe for hot soup or hot coffee. As another example, server 115 may be configured to access a search agent that may be configured to search a map, and to receive a name and a location of a shoe store located near end device 105.

In some embodiments, server 115 may be configured to receive, from end device 105, at least one input to select a service from multiple services that may be executable by server 115. For example, server 115 may be configured to receive, from end device, the input to select a service from a service list which is displayed on end device 105. Further, server 115 may be configured to transmit service information regarding the selected service to end device 105, and then, the service information regarding the selected service may be displayed on end device 105.

Further, server 115 may be configured to store the service information regarding the selected service in association with the information regarding object 125 selected by end device 105. For example, server 115 may be configured to generate information in which the selected service and selected object 125 are matched, and to store the generated information in a database. In some other embodiments, server 115 may be configured to store the service information regarding the selected service in association with the information regarding object 125 and an identifier of end device 105 that selected object 125 and the associated service.

Further, server 115 may be configured to store the service information regarding the selected service in association with the information regarding object 125 in a database of server 115 with a time stamp of receipt. Server 115 may be configured to store the service information regarding the selected service in association with the information regarding object 125 in a time sequence of receiving the input to select the service from end device 105. For example, server 115 may have a queue database that stores the service information associated with selected object 125 in the order of receipt.

Thus, FIG. 1 shows example system configuration 10 in which one or more embodiments of an IPTV service may be implemented, in accordance with various embodiments described herein.

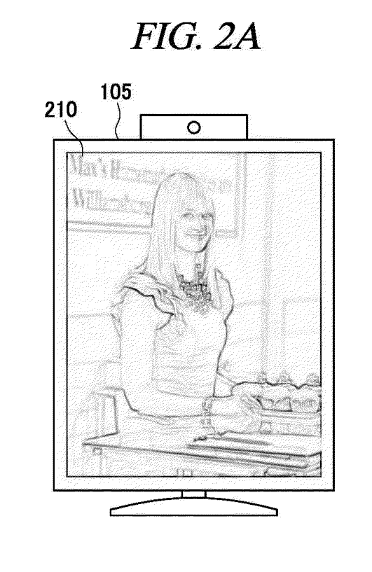

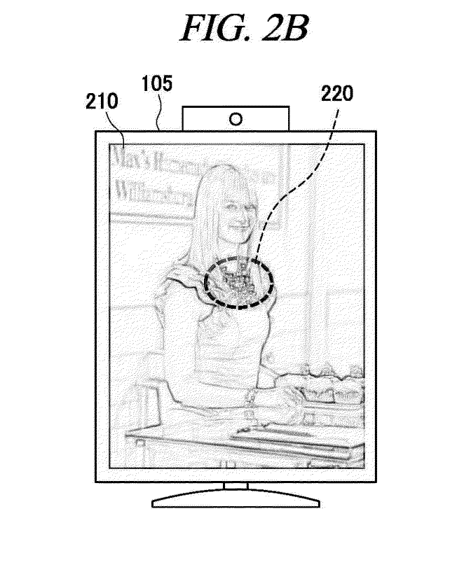

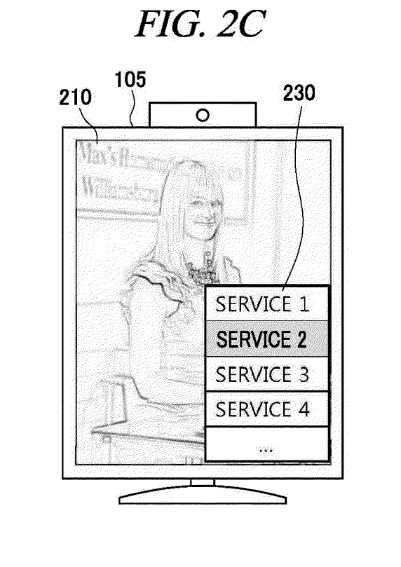

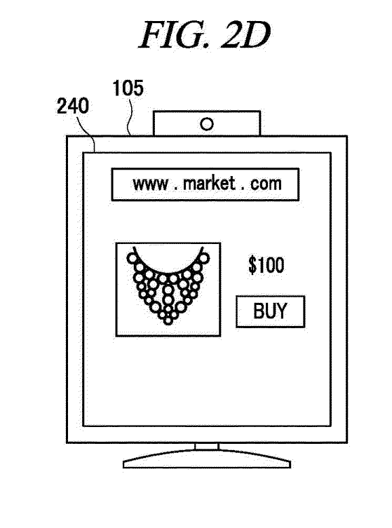

FIGS. 2A to 2D show aspects of an example of an end device 105 by which at least portions of an IPTV service may be implemented, in accordance with various embodiments described herein. As depicted in FIG. 2A, end device 105 may be configured to display an image 210 on a display that may be part of, or communicatively coupled to, end device 105. Image 210 may be at least one of a picture, a frame or a scene of IPTV content that includes at least one of video-on-demand content, real-time broadcasting content or user interactive content (e.g., games) provided by server 115 or an IPTV headend server.

End device 105 may be configured to receive an input to select an object 220 depicted on image 210. For example, as depicted in FIG. 2B, end device 105 may receive a touch input to select object 220, e.g., a necklace, depicted on image 210. End device 105 may be configured to then extract an image of object 220 from image 210, and to transmit, to server 115, information regarding object 220, which includes the extracted image of object 220.

End device 105 may be configured to receive, from server 115, service information regarding multiple services that are associated with object 220. Non-limiting examples of the multiple services that may be associated with object 220 may include searching for content, recommending content, displaying content, displaying an advertisement, recommending a service, and/or searching a map. As referenced herein, the “content” that may searched, recommended, and/or displayed may include, as non-limiting examples, a review of the selected object, a photo of the selected object, additional information regarding the selected object (e.g., a name, a cost, a color, a size, etc.) or a publication article regarding the selected object. End device 105 may be further configured to display the received service information regarding the multiple services associated with object 220 on a display. For example, as depicted in FIG. 2C, end device 105 may be configured to display, on the display, a list 230 of the available services that may be associated with object 220. Further, end device 105 may be configured to receive at least one input to select a service from the list 230 of services. For example, as depicted in FIG. 2C, end device 105 may be configured to receive at least one input to select “a service 2” (e.g., an online commerce service associated with object 220) from service list 230 displayed by end device 105.

Further, end device 105 may be configured to transmit the received input to select the service, e.g., service 2, to server 115, and to receive service information regarding the selected service from server 115. Further, end device 105 may be configured to display the service information regarding the selected service on the display. For example, as depicted in FIG. 2D, end device 105 may be configured to display, on the display, a web page 240 that sells selected object 220 (e.g., a necklace).

Thus, FIGS. 2A to 2D show aspects of an examples end device 105 by which at least portions of an IPTV service may be implemented, in accordance with various embodiments described herein.

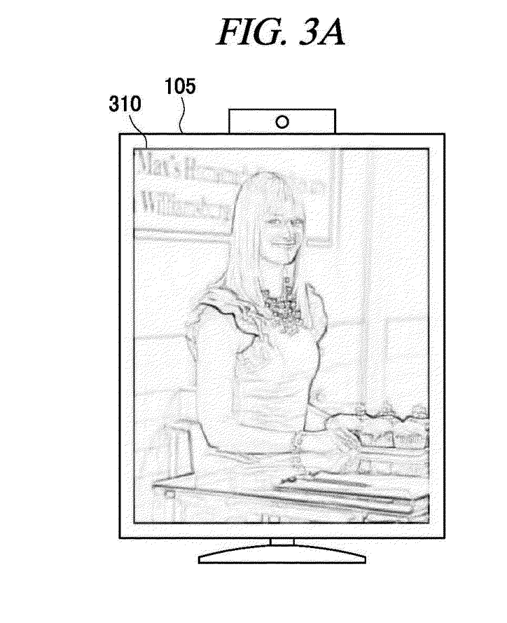

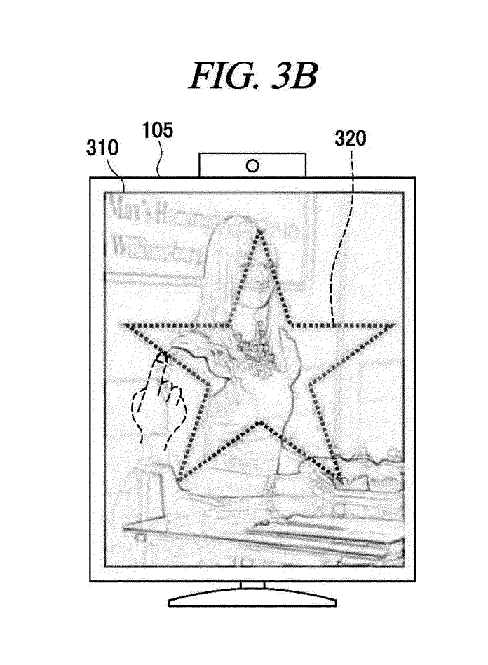

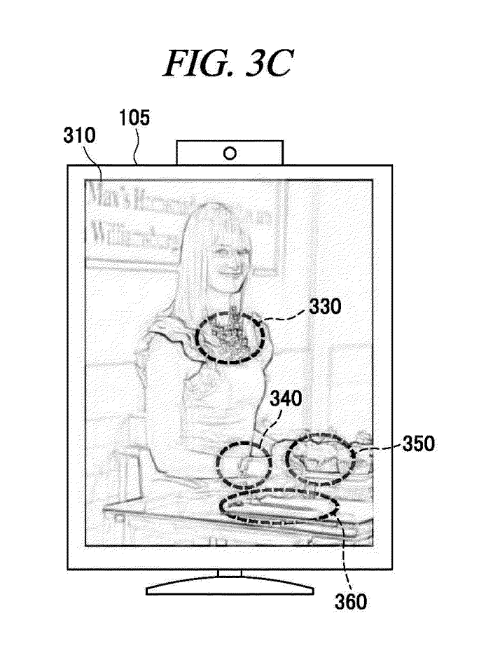

FIGS. 3A to 3C show aspects of another example end device 105 by which at least portions of an IPTV service may be implemented, in accordance with various embodiments described herein. As depicted in FIG. 3A, end device 105 may be configured to display an image 310 on a display that may be part of, or communicatively coupled to, end device 105. Image 310 may be at least one of a picture, a frame or a scene of IPTV content that includes at least one of video-on-demand content, real-time broadcasting content or user interactive content (e.g., games) provided by server 115 or an IPTV headend server.

Further, end device 105 may be configured to receive at least one predefined input such as one or more predefined gesture commands, one or more predefined touch commands, or one or more predefined voice commands. For example, as depicted in FIG. 3B, end device 105 may receive at least one predefined touch input 320, e.g., a star shape touch input, on image 310.

Further, multiple objects depicted on image 310 may be selected, and end device 105 may be configured to extract images of the multiple objects from image 310. For example, as depicted in FIG. 3C, end device 105 may be configured to extract images of a first object 330, e.g., a necklace, a second object 340, e.g., a watch, a third object 350, e.g., a scone, and a fourth object 360, e.g., a pencil. Then, end device 105 may be configured to transmit, to server 115, information regarding multiple objects 330, 340, 350, and 360, and to display service information regarding multiple services that are associated with multiple objects 330, 340, 350, and 360.

Thus, FIGS. 3A to 3C show aspects of another example end device 105 by which at least portions of an IPTV service may be implemented, in accordance with various embodiments described herein.

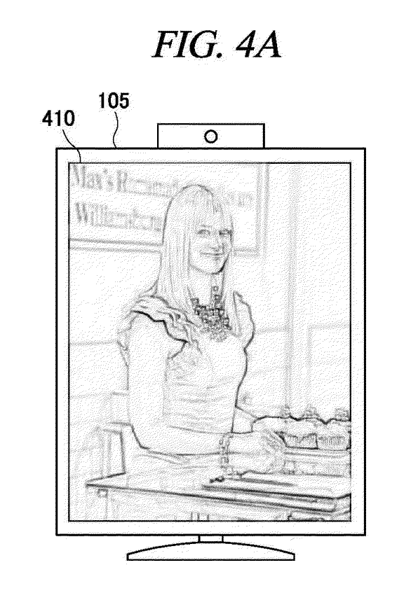

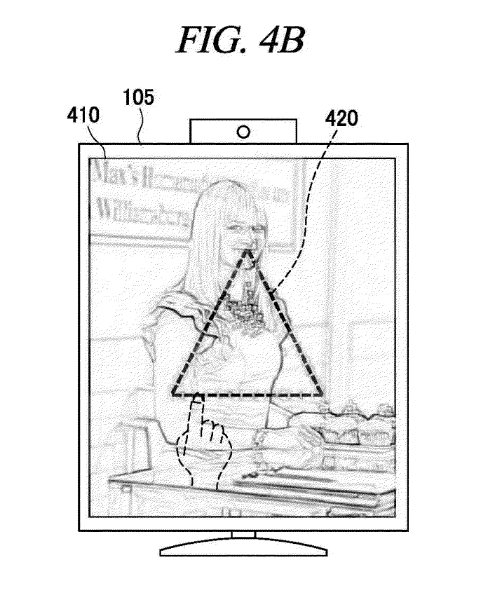

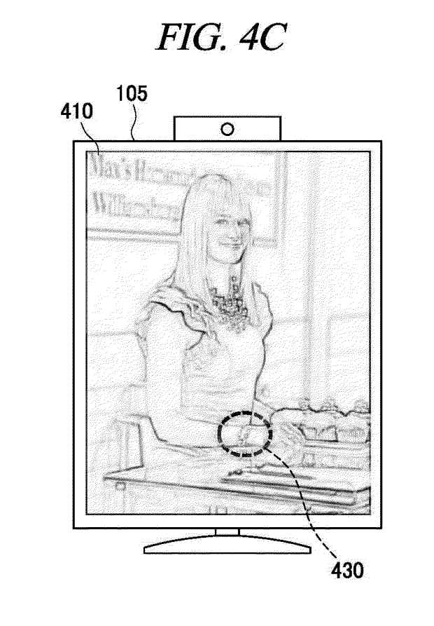

FIGS. 4A to 4C show aspects of still another example end device 105 by which at least portions of an IPTV service may be implemented, in accordance with various embodiments described herein. As depicted in FIG. 4A, end device 105 may be configured to display an image 410 on a display that may be part of, or communicatively coupled to, end device 105. Image 410 may be at least one of a picture, a frame or a scene of IPTV content that includes at least one of video-on-demand content, real-time broadcasting content or user interactive content (e.g., games) provided by server 115 or an IPTV headend server.

Further, end device 105 may be configured to receive at least one predefined input such as one or more predefined gesture commands, one or more predefined touch commands, or one or more predefined voice commands. For example, as depicted in FIG. 4B, end device 105 may receive a predefined touch input 420, e.g., a triangle shape touch input, on image 410.

Further, a predefined object 430 depicted on image 410 may be selected, and end device 105 may be configured to extract an image of predefined object 430 from image 410. For example, as depicted in FIG. 4C, end device 105 may be configured to extract an image of predefined object 430, e.g., a watch. In some embodiments, an owner or entity that controls an operation of server 115 or an advertiser or a manufacturer of predefined object 430 may register, with server 115, information regarding predefined object 430 and at least one corresponding predefined input 420 to select predefined object 430. Further, end device 105 may be configured to receive the information regarding predefined object 430 and corresponding predefined input 420 from server 115, and to store the received information. End device 105 may be configured to then select predefined object 430 based on the stored information.

Further, end device 105 may be configured to transmit, to server 115, information regarding predefined object 430, and to display service information regarding at least one service that are associated with predefined object 430.

Thus, FIGS. 4A to 4C show aspects of still another example end device 105 by which at least portions of an IPTV service may be implemented, in accordance with various embodiments described herein.

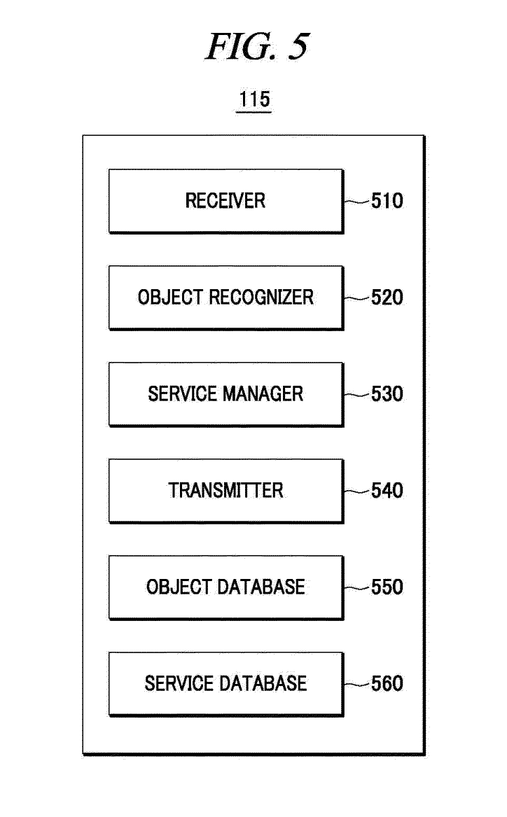

FIG. 5 shows an example server 115 by which at least portions of an IPTV service may be implemented, in accordance with various embodiments described herein. As depicted in FIG. 5, server 115 may include a receiver 510, an object recognizer 520, a service manager 530, a transmitter 540, an object database 550, and a service database 560. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of receiver 510, object recognizer 520, service manager 530, and transmitter 540 may be included in an instance of an application hosted on server 115.

Receiver 510 may be configured to receive, from end device 105 an image of an object, which may be extracted by end device 105. The object may be selected by end device 105 from a displayed image. Further, receiver 510 may be configured to receive, from end device 105, at least one input to select a service that may be associated with the selected object.

Object recognizer 520 may be configured to recognize the selected object from the image of the object received by receiver 510. Object recognizer 520 may be configured to recognize the object by using any well-known object recognition schemes. In some embodiments, object recognizer 520 may be configured to recognize a reference object from a data source. As referenced herein, the reference object may refer to an object which is already identified and/or stored in the data source. For example, but not as a limitation, the data source may include the Internet or a database that is communicatively coupled to server 115. Further, object recognizer 520 may be configured to match the image of the object with an image of the reference object. For example, object recognizer 520 may be configured to calculate a similarity between the image of the object and the image of the reference object. Further, object recognizer 520 may be configured to select the object based on the matching result (e.g., calculated similarity), and to recognize the object automatically. Further, object recognizer 520 may be configured to retrieve object information regarding the recognized object from object database 550. Non-limiting examples of the information regarding the object may include at least one of an image of the object, a unique identifier assigned to the object, or a name of the object.

Service manager 530 may be configured to identify at least one service from among multiple services that may be executable by server 115, based on a correspondence between the retrieved object information and service information stored in service database 560. By way of example, service manager 530 may be configured to search for and/or select at least one service that may correspond to the retrieved object information from service database 560, based at least in part on information in which the object information and service information are matched. For example, but not as a limitation, the service that may be executable by server 115 may include searching for content, recommending content, displaying content, displaying an advertisement, recommending a service, and/or searching a map. As referenced herein, the “content” that may searched, recommended, and/or displayed may include, as non-limiting examples, a review of the recognized object, a photo of the recognized object, additional information regarding the recognized object (e.g., a name, a cost, a color, a size, etc.) or a publication article regarding the recognized object.

Further, service manager 530 may be configured to identify and determine the at least one service, based at least in part on information regarding environmental conditions. Non-limiting examples of the information regarding environmental conditions may include at least one of a current time, current weather conditions, a current location of end device 105, or a service that was previously selected by end device 105. Service manager 530 may be configured to associate the at least one service with the information regarding environmental conditions at which the transmission of the image of the object, from end device 105 to server 115, is made. Further, service manager 530 may be configured to identify the at least one service associated with the object, based on the determined intention or mood.

In some embodiments, service manager 530 may be configured to execute the identified service by accessing to a service agent that executes the identified service. Further, service manager 530 may be configured to receive a result of the executed service from the service agent, and to generate the service information regarding the identified service based at least in part on the received result. By way of example, but not limitation, the service agent may refer to a module, a processor or an engine that executes a service. Further, the service agent may be located in at least one of server 115, or an IPTV headend server that is communicatively coupled to end device 105 and/or server 115. The service agent may include at least one of a search agent, a recommendation agent, a content providing agent, or an advertisement agent. As a non-limiting example, the service information regarding the service may include at least one of an advertisement about the object, a review of the object by other users, or an online commerce service associated with the object.

Transmitter 540 may be configured to transmit, to end device 105, the service information that corresponds to the at least one service which is identified by service manager 530. Then, the transmitted service information that is associated with the object selected by end device 105 may be displayed on a display that is communicatively coupled to end device 105.

Object database 550 may be configured to store the retrieved object information. In some embodiments, object database 550 may be configured to store the object information in association with an identifier of end device 105. Non-limiting examples of the identifier of end device 105 may include an internet protocol (IP) address of end device 105, a serial number assigned to end device 105, or a unique identifier of end device 105. Further, object database 550 may be configured to store the object information with a time stamp of receipt. For example, object database 550 may be configured to store the object information in an order in which the image of the object is received by receiver 510. In some other embodiments, object database 550 may be configured to store the object information in association with information regarding at least one service that is related to the object.

Service database 560 may be configured to store information regarding multiple services in association with object information regarding one or more objects associated with each service. Non-limiting examples of the object information may include at least one of images of the objects, unique identifiers assigned to the objects, or names of the objects. In some embodiments, service database 560 may be configured to store service information regarding at least one service that is selected by end device 105 and/or transmitted to end device 105 in association with the identifier of end device 105 and/or with a time stamp of receipt. For example, service database 560 may be configured to store the service information in an order in which the input to select the service is received by receiver 510.

Thus, FIG. 5 shows an example server 115 by which at least portions of an IPTV service may be implemented, in accordance with various embodiments described herein.

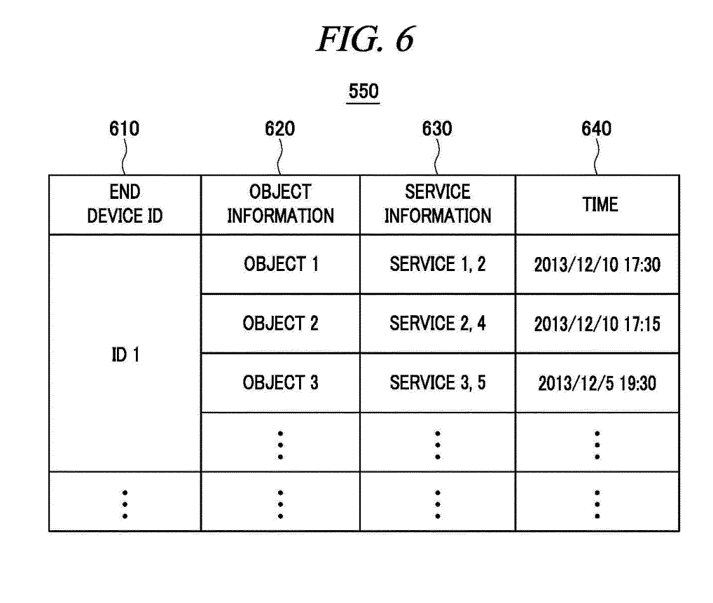

FIG. 6 shows an example object database 550 of a server 115 by which at least portions of an IPTV service may be implemented, in accordance with various embodiments described herein. In some embodiments, object database 550 may be configured to store object information regarding multiple objects in association with an identifier of end device 105 that selects the multiple objects; at least one service that corresponds to the multiple objects; and a time at which server 115 received, from end device 105, an input to select the multiple objects. For example, but not as a limitation, as depicted in FIG. 6, object database 550 may include an end device ID field 610, an object information field 620, a service information field 630 and a time field 640. However, kinds of information included in object database 550 may be changed. For example, end device ID field 610 may include information regarding an identifier of end device 105. Further, object information field 620 may include information regarding a representation or an identifier that represents each object. Further, service information field 630 may include information regarding a representation or an identifier that represents each service. Further, time field 640 may include information regarding a time at which server 115 received, from end device 105, an input to select each object.

Thus, FIG. 6 shows an example object database 550 of server 115 by which at least portions of an IPTV service may be implemented, in accordance with various embodiments described herein.

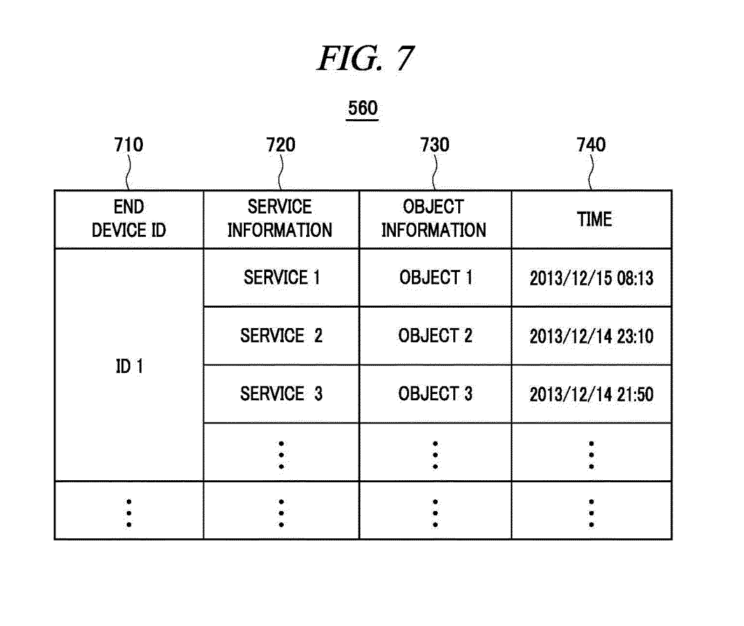

FIG. 7 shows an example service database 560 of a server 115 by which at least portions of an internet protocol television service may be implemented, in accordance with various embodiments described herein. In some embodiments, service database 560 may be configured to store service information regarding multiple services in association with an identifier of end device 105 by which the multiple services was selected and/or to which the multiple services transmitted; at least one object that corresponds to the multiple services; and a time at which server 115 received, from end device 105, an input to select the multiple services or at which server 115 transmitted the multiple services to end device 105. For example, but not as a limitation, as depicted in FIG. 7, service database 560 may include an end device ID field 710, a service information field 720, an object information field 730, and a time field 740. However, kinds of information included in service database 560 may be changed. For example, end device ID field 710 may include information regarding an identifier of end device 105. Further, service information field 720 may include information regarding a representation or an identifier that represents each service. Further, object information field 730 may include information regarding a representation or an identifier that represents each object. Further, time field 740 may include information regarding a time at which server 115 received, from end device 105, an input to select each service or at which server 115 transmitted each service to end device 105.

Thus, FIG. 7 shows an example service database 560 of server 115 by which at least portions of an IPTV service may be implemented, in accordance with various embodiments described herein.

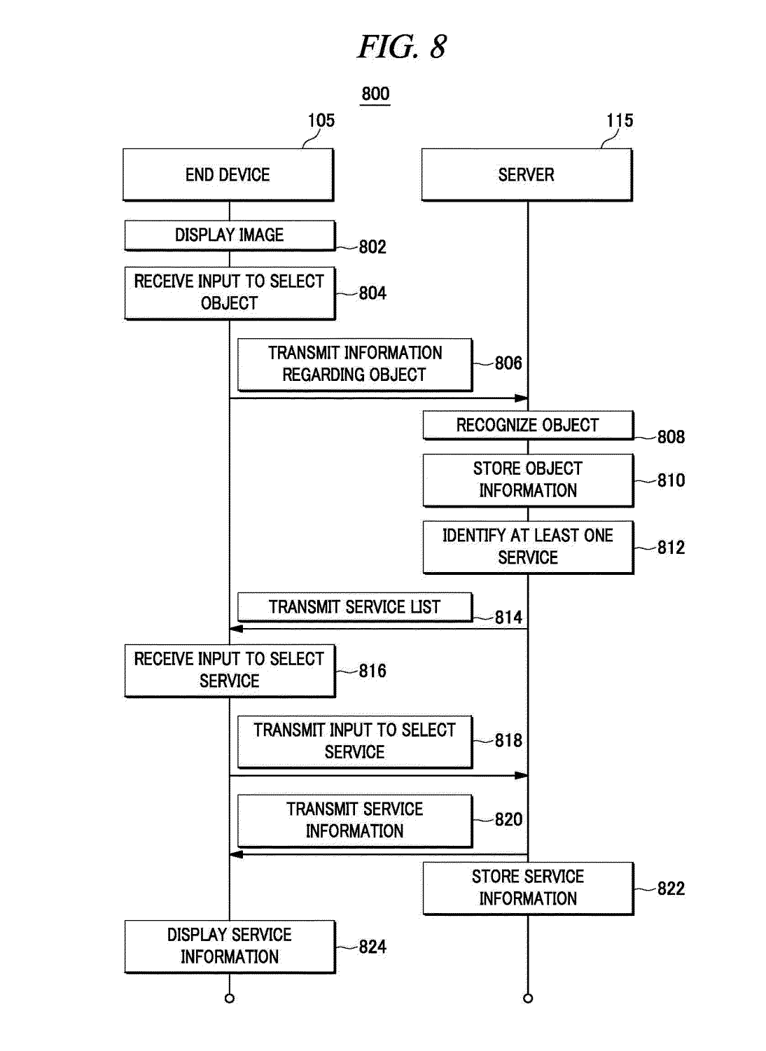

FIG. 8 shows an example processing flow 800 of operations by which at least portions of an IPTV service may be implemented, in accordance with various embodiments described herein. The operations of processing flow 800 may be implemented in system configuration 10 including, at least, end device 105, mobile device 110 and server 115, as illustrated in FIG. 1. Processing flow 800 may include one or more operations, actions, or functions as illustrated by one or more blocks 802, 804, 806, 808, 810, 812, 814, 816, 818, 820, 822 and/or 824. Although illustrated as discrete blocks, various blocks may be divided into additional blocks, combined into fewer blocks, or eliminated, depending on the desired implementation. Processing may begin at block 802.

Block 802 (Display Image) may refer to end device 105 displaying an image on a display that may be part of, or communicatively coupled to, end device 105. For example, but not as a limitation, the displayed image may refer to at least one of a picture, a frame or a scene of video-on-demand (VOD) content or a frame or a scene of real-time broadcasting content, which may be received from server 115 via network 100. Processing may proceed from block 802 to block 804.

Block 804 (Receive Input to Select Object) may refer to end device 105 receiving an input to select an object depicted on the image displayed at block 802. For example, the input may be generated by a user of end device 105. Non-limiting examples of the input may include at least one or more voice commands, one or more gesture commands, one or more text commands, one or more touch commands or one or more pointer commands. In some embodiments, at block 804, end device 105 may receive, from mobile device 110, one or more signals that represent the input to select the object. Processing may proceed from block 804 to block 806.

Block 806 (Transmit Information regarding Object) may refer to end device 105 transmitting, to server 115, information regarding the object selected at block 804. At block 806, end device 105 may extract an image of the object from the image displayed at block 802. Further, end device 105 may transmit, to server 115, the information regarding the object, which includes the extracted image of the object. Processing may proceed from block 806 to block 808.

Block 808 (Recognize Object) may refer to server 115 recognizing the selected object from the image of the object transmitted at block 806. Server 115 may recognize the object from the information including the extracted image of the object by using any well-known object recognition schemes. Processing may proceed from block 808 to block 810.

Block 810 (Store Object Information) may refer to server 115 storing object information regarding the object recognized at block 808 in a database of server 115 in association with an identifier of end device 105. Non-limiting examples of the identifier of end device 105 may include an internet protocol (IP) address of end device 105, a serial number assigned to end device 105, or a unique identifier of end device 105. For example, but not as a limitation, the object information may include at least one of the image of the object, a unique identifier assigned to the object, a name of the object, etc. Further, server 115 may store the object information with a time stamp of receipt. For example, server 115 may store the object information an order in which the image of the object is received from end device 105. Processing may proceed from block 810 to block 812.

Block 812 (Identify At Least One Service) may refer to server 115 identifying at least one services that are associated with the selected object. At block 812, server 115 may identify at least one services from among multiple services that are executable by server 115 with reference to the information regarding the object. By way of example, server 115 may search for and select at least one service that corresponds to the object from a database that stores information in which the object and a corresponding service are matched. For example, but not as a limitation, the service that is executable by server 115 may include searching for content, recommending content, displaying content, displaying an advertisement, recommending a service, and/or searching a map. As referenced herein, the “content” that may searched, recommended, and/or displayed may include, as non-limiting examples, a review of the selected object, a photo of the selected object, additional information regarding the selected object (e.g., a name, a cost, a color, a size, etc.) or a publication article regarding the selected object. In some embodiments, server 115 may identify and determine the at least one service, based at least in part on information regarding environmental conditions. Non-limiting examples of the information regarding environmental conditions may include at least one of a current time, current weather conditions, a current location of end device 105, or a service that was previously selected by end device 105. Processing may proceed from block 812 to block 814.

Block 814 (Transmit Service List) may refer to server 115 transmitting, to end device 105, a list of the at least one services which are identified at block 812. Further, the transmitted service list may be displayed by end device 105. Processing may proceed from block 814 to block 816.

Block 816 (Receive Input to Select Service) may refer to end device 105 receiving an input to select a service from the list of the at least one services. Processing may proceed from block 816 to block 818.

Block 818 (Transmit Input to Select Service) may refer to end device 105 transmitting, to server 115, the input to select the service, which is received at block 816. Processing may proceed from block 818 to block 820.

Block 820 (Transmit Service Information) may refer to server 115 transmitting, to end device 105, information regarding the service, which is selected at block 816. As a non-limiting example, the information regarding the service associated with the selected object may include at least one of an advertisement about the object, a review of the object by other users, or an online commerce service associated with the object. Processing may proceed from block 820 to block 822.

Block 822 (Store Service Information) may refer to server 115 storing the information regarding the selected service, which is transmitted at block 820, in a database of server 115 in association with the identifier of end device 105 and/or with a time stamp of receipt. For example, server 115 may store the information regarding selected service in a time sequence of receiving the input to select the service at block 818. Processing may proceed from block 822 to block 824.

Block 824 (Display Service Information) may refer to end device 105 displaying the service information which is transmitted at block 820 on the display that may be part of, or communicatively coupled to, end device 105.

Thus, FIG. 8 shows an example processing flow 800 of operations by which at least portions of an IPTV service may be implemented, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

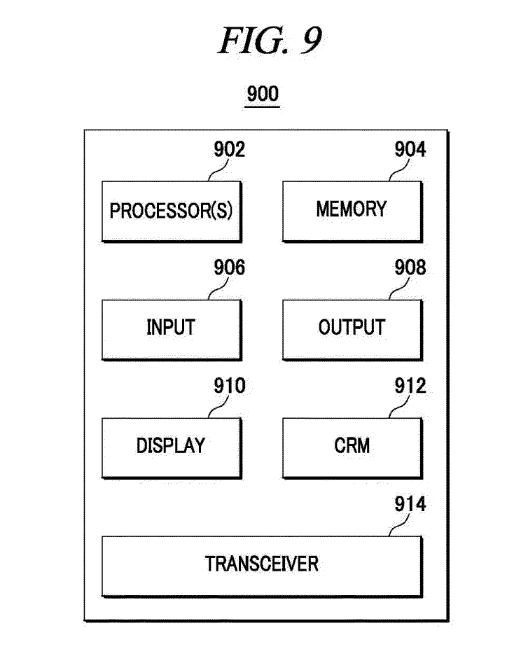

FIG. 9 shows an illustrative computing embodiment, in which any of the processes and sub-processes of an IPTV service may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 900 may typically include, at least, one or more processors 902, a system memory 904, one or more input components 906, one or more output components 908, a display component 910, a computer-readable medium 912, and a transceiver 914.

Processor 902 may refer to, e.g., a microprocessor, a microcontroller, a digital signal processor, or any combination thereof.

Memory 904 may refer to, e.g., a volatile memory, non-volatile memory, or any combination thereof. Memory 904 may store, therein, an operating system, an application, and/or program data. That is, memory 904 may store executable instructions to implement any of the functions or operations described above and, therefore, memory 904 may be regarded as a computer-readable medium.

Input component 906 may refer to a built-in or communicatively coupled keyboard, touch screen, or telecommunication device. Alternatively, input component 906 may include a microphone that is configured, in cooperation with a voice-recognition program that may be stored in memory 904, to receive voice commands from a user of computing device 900. Further, input component 906, if not built-in to computing device 900, may be communicatively coupled thereto via short-range communication protocols including, but not limitation, radio frequency or Bluetooth.

Output component 908 may refer to a component or module, built-in or removable from computing device 900, that is configured to output commands and data to an external device.

Display component 910 may refer to, e.g., a solid state display that may have touch input capabilities. That is, display component 910 may include capabilities that may be shared with or replace those of input component 906.

Computer-readable medium 912 may refer to a separable machine readable medium that is configured to store one or more programs that embody any of the functions or operations described above. That is, computer-readable medium 912, which may be received into or otherwise connected to a drive component of computing device 900, may store executable instructions to implement any of the functions or operations described above. These instructions may be complimentary or otherwise independent of those stored by memory 904.

Transceiver 914 may refer to a network communication link for computing device 900, configured as a wired network or direct-wired connection. Alternatively, transceiver 914 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A system, comprising:
an end device configured to:
display an image,
receive an input to select an object depicted on the displayed image, and
transmit information regarding the object; and
a server configured to:
receive the information regarding the object from the end device,
store the received information regarding the object with a time of receipt,
identify at least one service associated with the object with reference to the received information regarding the object, and
transmit service information regarding the identified at least one service to the end device.

2. The system of claim 1, wherein the service includes at least one of searching content, recommending content, displaying content, displaying an advertisement, or recommending a service.

3. The system of claim 1, wherein the end device is further configured to:
receive an input to select a service from the at least one service, and
transmit the input to select the service to the server, and
wherein the server is further configured to store the service information regarding the selected service in association with the information regarding the object, based at least in part on the transmitted input to select the service.

4. The system of claim 3, wherein the server is further configured to store the service information regarding the selected service with a time of receipt.

5. The system of claim 1, wherein the server is further configured to store the received information regarding the object in association with an identifier of the end device.

6. The system of claim 1, wherein the displayed image includes at least one of a picture, a frame of video-on-demand (VOD) content or a frame of real-time broadcasting content,
wherein a plurality of distinguishable objects are depicted on the displayed image, and
wherein the object is one of the plurality of distinguishable objects.

7. The system of claim 1, wherein the service information includes at least one of an advertisement about the object, a review of the object, an online commerce service associated with the object.

8. The system of claim 1, wherein the input includes at least one of a voice command, a gesture command, a text command, a touch command, or a pointer command.

9. The system of claim 1, wherein the server is further configured to:
identify the at least one service based at least in part on environment information that includes at least one of a current time, current weather conditions, a current location of the end device, or a service that was previously selected by the end device.

10. The system of claim 1, wherein the end device is further configured to extract an image of the object from the displayed image, and
wherein the information regarding the object includes the extracted image of the object.

11. The system of claim 10, wherein the input includes at least one of a predefined gesture command, a predefined touch command or a predefined voice command, and
wherein the end device is further configured to extract images of a plurality of objects from the displayed image, and
wherein the information regarding the object includes the extracted images of the plurality of objects.

12. The system of claim 10, wherein the server is further configured to transmit, to the end device, information regarding a predefined object, and
wherein the end device is further configured to extract an image of the predefined object from the displayed image, based at least in part on the transmitted information regarding the predefined object, if the end device receives a predefined input.

13. The system of claim 1, wherein the end device is further configured to:
receive the transmitted service information from the server, and
display the received service information.

14. A server, comprising:
a receiver configured to receive, from an end device, an image of an object;
an object recognizer configured to:
recognize the object from the image, and
retrieve object information regarding the object;
an object database configured to store the object information;
a service database configured to store service information regarding a plurality of services;
a service manager configured to identify at least one of the plurality of services based on a correspondence between the retrieved object information and any of the stored service information; and
a transmitter configured to transmit the service information corresponding to the identified at least one service to the end device.

15. The server of claim 14, wherein the receiver is further configured to receive, from the end device, an input to select a service from the identified at least one service, and
wherein the service database is further configured to store the service information regarding the selected service in association with the object information, based at least in part on the input to select the service.

16. The server of claim 15, wherein the object database is configured to store the object information in association with an identifier of the end device, and
wherein the service database is further configured to store the service information regarding the selected service in association with the identifier of the end device.

17. The server of claim 14, wherein the service manager is further configured to identify the at least one service based at least in part on environment information that includes at least one of a current time, current weather conditions, a current location of the end device, or a service that was previously selected by the end device.

18. The server of claim 14, wherein the service information includes at least one of an advertisement about the object, a review of the object, an online commerce service associated with the object.

19. The server of claim 14, wherein the object recognizer is configured to recognize the object from the image by:
recognizing a reference object from a data source,
matching the image of the object with an image of the reference object, and
selecting the object based on the matching.

20. The server of claim 19, wherein the data source includes the Internet.

21. A method performed under control of a server, comprising:
receiving, from an end device, information regarding an object depicted on an image displayed by the end device;
identifying at least one service associated with the object from among a plurality of services with reference to the received information regarding the object; and
transmitting service information regarding the identified at least one service to the end device.

22. The method of claim 21, further comprising:
receiving, from the end device, an input to select a service from the identified at least one service; and
storing the service information regarding the selected service in association with the information regarding the object, based at least in part on the input to select the service.

23. The method of claim 22, further comprising:
storing the received information regarding the object with a time of receipt in association with an identifier of the end device, and
wherein the storing of the service information regarding the selected service includes storing the service information regarding the selected service in association with the identifier of the end device.

24. The method of claim 21, wherein the identifying is based at least in part on environment information that includes at least one of a current time, current weather conditions, a current location of the end device, or a service that was previously selected by the end device.

25. The method of claim 21, wherein the service information includes at least one of an advertisement about the object, a review of the object, an online commerce service associated with the object.
